(19) United States
(12) Patent Application Publication
(10) Pub. No.: US 2006/0023977 A1
(43) Pub. Date: Feb. 2, 2006

(54) Coupled structure of rolling elements and a roller bearing using the same

(75) Inventor: Shigemasa Itabashi, Kamakura-shi (JP)

Correspondence Address: STEINBERG & RASKIN, P.C., 1140 AVENUE OF THE AMERICAS, 15th FLOOR, NEW YORK, NY, 10036-5803, US

(73) Assignee: NIPPON THOMPSON CO., LTD., Tokyo (JP)

(21) Appl. No.: 11/166,854

(22) Filed: Jun. 24, 2005

(30) Foreign Application Priority Data
Jul. 27, 2004 (JP) 2004-218327

(51) Int. Cl. F16C 29/04

(52) U.S. Cl. 384/13

(57) ABSTRACT

A coupled structure of rolling elements which is capable of adequately supplying a lubricating oil component to the rolling elements without waste of the lubricating oil component, and a bearing using the coupled structure. In the coupled structure of rolling elements (1) including a coupled assembly (3) of rolling elements (1) coupled by regularly arranging the rolling elements (1) such as needle rollers in a direction at right angles to the longitudinal direction of the rolling element (1) and interposing a retaining material (2) formed of a solid lubricant between the rolling elements (1). A feature is that a curved-face (1a) of each of the rolling elements (1) exposed on one of faces of the coupled assembly (3) is wider than a curved-face (1b) of the rolling element (1) exposed on the other face of the coupled assembly (3).

### BACKGROUND OF THE INVENTION

1. Field of the Invention

This invention relates to the coupled structure of rolling elements, such as needle rollers or cylindrical rollers, and a roller bearing using the rolling elements of the coupled structure.

2. Description of the Related Art

In a roller bearing, for example, one of the conventionally known ideas when needle-shaped rolling elements are mounted on the outer race is that the rolling elements are temporarily stuck to the inner circumferential face of the outer race with a coating of grease applied to the periphery of the rolling elements to prevent the rolling elements from becoming detached from the outer race. However, the limited degree of viscosity of the grease for sticking the rolling elements to the outer race gives rise to the problem of the rolling elements coming out of position during handling by the user or in the process of assembling the rolling bearing.

Conventionally known methods for solving this problem include the coupled structure of the rolling elements.

This conventional coupled structure is composed of a coupled assembly of rolling elements retained by a retaining material formed of a solid lubricant. The retaining of the coupled assembly of the rolling elements by a retaining material makes the mounting of the rolling elements on the outer race easier than in the case where the rolling elements are stuck to the outer race simply by the viscosity of the grease. Because the retaining material is formed of a solid lubricant, the heat generated when the bearing is used precipitates or melts the oil component of the lubricant. The precipitated or melted lubricating-oil component seeps out and is supplied to the rolling elements, thereby maintaining the lubricating properties.

The rolling elements retained by the retaining material are exposed approximately equally on the two faces of the coupled assembly. In other words, the rolling elements are also exposed on the face of the coupled assembly which is out of contact with the outer race. Further, the adjacent rolling elements are arranged at wide intervals.

The coupled assembly of the rolling elements as described above and a bearing using such a coupled assembly are disclosed in Japanese Examined Patent Publication 46-009082, for example.

The conventional coupled structure as described above has the problem of the lubricating oil component going to waste because intervals are kept between adjacent rolling elements and the lubricating oil component seeping out from the solid lubrication runs away from each interval between the rolling elements.

In addition, there is another problem of the bearing being incapable of receiving a large load because when the intervals between adjacent rolling elements are increased, the number of rolling elements in the coupled assembly is decreased.

Further, the great exposure of the rolling elements on the face of the coupled assembly which is out of contact with the outer race reduces the contact area between the retaining material and the rolling elements. This gives rise to another problem. That is, the smaller the contact area between the rolling elements and the retaining material, the lower the amount of lubricating oil component of the solid lubricant supplied to the rolling elements.

### SUMMARY OF THE INVENTION

It is an object of the present invention to provide a coupled structure of rolling elements which is capable of adequately supplying a lubricating oil component to the rolling elements without waste of the lubricating oil component, and a bearing using the coupled structure.

The present invention is based on a coupled structure of rolling elements including a coupled assembly of rolling elements coupled by regularly arranging rolling elements such as needle rollers or the like in a direction at right angles to the longitudinal direction of the rolling element and by interposing a retaining material formed of a solid lubricant between the rolling elements.

A feature of the present invention is that a curved-face of each of the rolling elements exposed on one of faces of the coupled assembly is wider than a curved-face of the rolling element exposed on the other face of the coupled assembly.

Another feature of the present invention is that the coupled assembly is bent in a ring shape with the wider exposed curved-faces of the rolling elements facing outward.

In view of these features, because the exposed cured-face of each rolling element on one of the faces of the coupled assembly is wider than the exposed curved-face of the rolling element on the other face of the coupled assembly, the coupled assembly is easily bent into a ring shape with the face with the wider exposed curved-faces facing outward. With the facilitation of the bending process, the coupled assembly constituted of the rolling elements and the retaining material can be easily mounted on the outer race.

Further, because the exposed curved-face of each rolling element on the other face of the coupled assembly is smaller, the contact area between the rolling elements and the retaining material on the other face of the coupled assembly is increased, resulting in an improvement in lubricating performance.

Yet another feature of the present invention is that the rolling elements adjacent to each other are arranged close to each other and a groove is formed between the wider exposed curved-faces of the adjacent rolling elements.

In view of this feature, because adjacent rolling elements are arranged close to each other, grooves are created between the curved-faces of the adjacent rolling elements more widely exposed on the coupled assembly. The lubricating oil component seeping out from the retaining material accumulates in the grooves, and then the accumulated lubricating oil component is supplied to the rolling elements. Accordingly, it is possible to eliminate waste of the lubricating oil component and to keep the maintenance-free conditions for a long time.

Further, when the coupled assembly is bent in a ring shape with the grooves facing outward, the grooves provide a clearance for the outward bending face to facilitate the bending of the coupled assembly.

The present invention is also based on a roller bearing that has a coupled assembly constituted of the rolling elements such as needle rollers or the like regularly arranged in a direction at right angles to the longitudinal direction of the rolling element and a retaining material formed of a solid lubricant and interposed between the rolling elements, and an outer race on which the coupled assembly bent in a ring shape is mounted.

A feature of the present invention is that a curved-face of each of the rolling elements exposed on one face of the coupled assembly is wider than a curved-face of the rolling element exposed on the other face of the coupled assembly, and the coupled assembly is bent in a ring shape with the wider exposed curved-faces of the rolling elements facing outward, and further the rolling elements bent in the ring shape is mounted on the outer race.

In view of this feature, the coupled assembly constituted of the rolling elements and the retaining material is easily mounted on the outer race. Further, an improvement in lubricating performance is possible.

Another feature of the present invention is that oil-supply holes are formed on the outer race.

In view of this feature, it is possible to supply an additional lubricant at any time.

### BRIEF DESCRIPTION OF THE DRAWINGS

FIG. 1 is a sectional view of a coupled assembly illustrating an embodiment of the present invention.

FIG. 2 is a sectional view illustrating the coupled assembly curved.

FIG. 3 is a sectional view taken along the III-III line in FIG. 1.

FIG. 4 is a perspective view of a jig used for forming the coupled assembly.

FIG. 5 is a perspective view of an outer race on which the coupled assembly is to be mounted.

FIG. 6 is a sectional view of the outer race having the coupled assembly mounted thereon.

### DETAILED DESCRIPTION OF THE PREFERRED EMBODIMENT

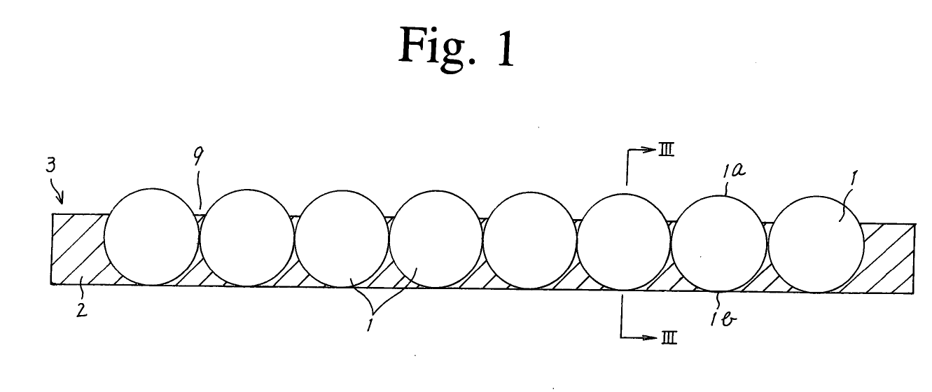

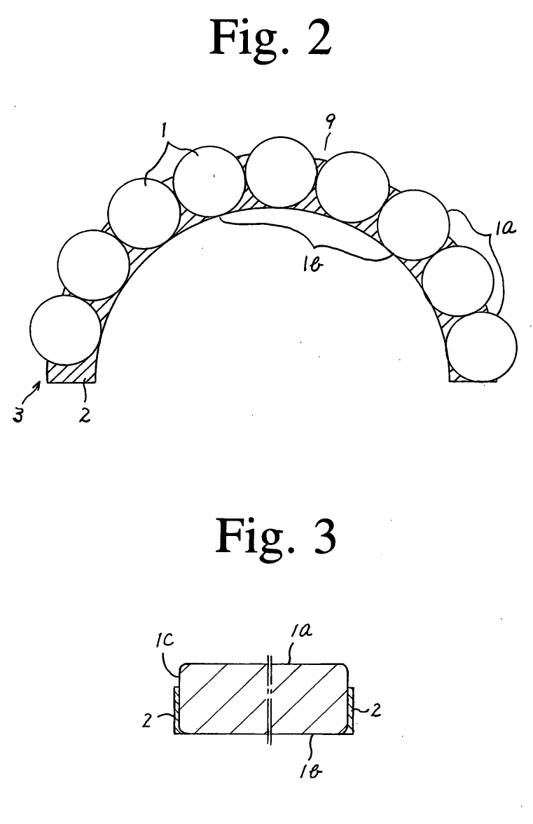

In the embodiment illustrated in FIGS. 1 to 3, rolling elements 1 such as needle rollers are retained in a retaining material 2 formed of a solid lubricant to form a coupled assembly 3 of the rolling elements 1. The coupled assembly 3 is formed as follows.

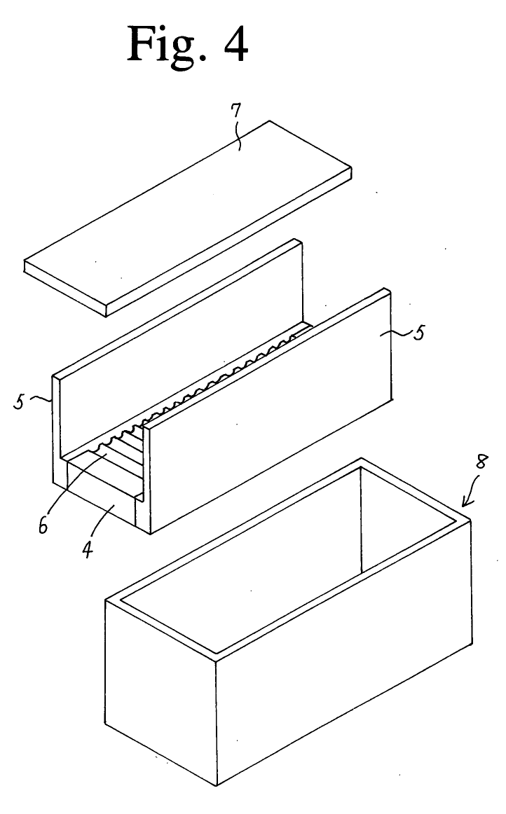

FIG. 4 illustrates a jig for forming the coupled assembly 3. Two side members 5 are placed on either side of a bottom member 4. The bottom member 4 has a plurality of recesses 6 formed contiguously in the longitudinal direction of the bottom member 4. The length of each of the recesses 6 in the width direction of the bottom member 4 is approximately equal to the length of the rolling element 1. Further, the arc shape of the bottom of the recess 6 is identical in curvature with the outer circumference of the rolling element 1. When the plurality of rolling elements 1 is fitted into the respective recesses 6, adjacent rolling elements 1 are contiguous with each other.

The distance between the opposed side members 5 is somewhat longer than the length of each of the recesses 6, that is, the length of the rolling element 1. A lid member 7 is placed over the bottom member 4. The lid member 7 has a width approximately equal to the distance between the opposed side members 5, and a length equal to that of the bottom member 4. Accordingly, the lid member 7 is nearly exactly fitted into the space between the opposed side members 5.

The bottom member 4 together with the side members 5 attached to both the sides thereof is accommodated in a housing 8.

After the bottom member 4 with the side members 5 has been accommodated in the housing 8, the housing 8 is charged with a liquid mixture forming the base of the solid lubricant. The liquid mixture consists of a main base of lubricating oil combined with fine particles of ultra-high molecular-weight polyolefin resin in proportions by weight of 75:25.

After the housing 8 has been charged with this liquid mixture, the rolling elements 1 are placed into the recesses 6 of the bottom member 4 so as to be arranged on the bottom member 4. After a predetermined number of rolling elements 1 have been arranged on the bottom member 4, the lid member 7 is placed to cover them. At this point, as a presetting, the faces of the rolling elements 1 facing the lid member 7 are not submerged in the liquid mixture, that is, the faces of the rolling elements 1 are exposed above the liquid mixture.

After that, the housing 8 is put in a furnace and heated in order for the liquid mixture in the housing 8 to be solidified.

After the liquid mixture has been solidified in this manner to result in a solid lubricant, the housing 8 is removed from the furnace, and after the heat has dissipated, the solid lubricant is uncased from the housing 8, thus forming a coupled assembly 3 as shown in FIGS. 1 to 3.

The coupled assembly 3 thus formed has, as shown in FIG. 1, the exposed curved-face 1a of each of the rolling elements 1 on one face of the coupled assembly 3 larger in area than the exposed curved-face 1b of the rolling element 1 on the other face of the coupled assembly 3. This results from the presetting for charging with the liquid mixture as described earlier.

In this manner, the exposed curved-face 1a of each of the rolling elements 1 on one face of the coupled assembly 3 has an area larger than that of the exposed curved-face 1b of the rolling element 1 on the other face of the coupled assembly 3. Further, the rolling elements 1 are contiguous with each other. As a result, a groove 9 is formed between adjacent exposed curved-faces of the rolling elements 1.

Further, the length of each of the recesses 6 of the bottom member 4 is set shorten than the distance between the opposed side members 5, so that the retaining material 2 extends into the two ends 1c of each of the rolling elements 1, as shown in FIG. 3.

The coupled assembly 3 thus formed is bent in a ring shape with the exposed curved-faces 1a facing outward. When the coupled assembly 3 is bent in this manner, the grooves 9 provide a clearance for the outward bending face to facilitate the bending of the coupled assembly 3.

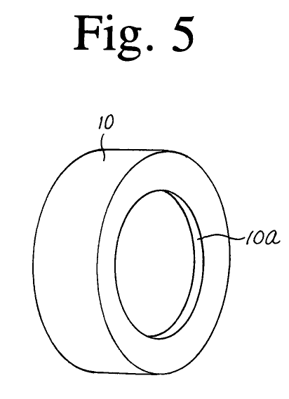

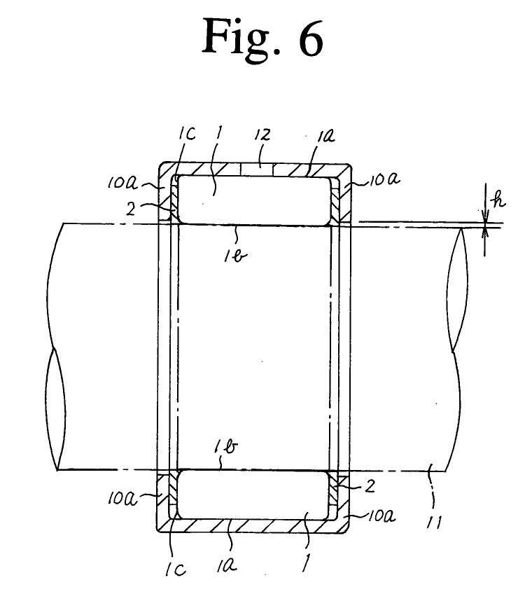

The coupled assembly 3 bent in such a ring shape is mounted on an outer race 10 as shown in FIGS. 5 and 6. The outer race 10 is structured as follows. The outer race 10 has two ring-shaped portions 10a formed on the two side faces. The distance between the opposed ring-shaped portions 10a is approximately equal to the length of the rolling element 1 including the retaining material 2 in the axis direction of the rolling element 1 as shown in FIG. 3. Accordingly, when the coupled assembly 3 bent in such a ring shape is mounted on the outer race 10, as shown in FIG. 6, the portion of the retaining material 2 corresponding to the two ends 1a of each rolling member 1 comes into contact with the ring-shaped portions 10a of the outer race 10.

A shaft 11 is inserted into the outer race 10 with the coupled assembly 3 thus mounted thereon. As the shaft 11 and the outer race 10 are rotated relatively to each other, the rolling elements 1 also rotate. At this point, the lubricating oil component included in the retaining material 2 seeps out and is supplied to the rolling surfaces of the rolling elements 1 for lubrication.

In particular, in the embodiment, because each of the grooves 9 is formed between adjacent exposed curved-faces 1a of the rolling elements 1, the lubricating oil component seeping out in this manner accumulates in the grooves 9. The accumulation of the lubricating oil component in the grooves 9 prevents the dissipating of the lubricating oil component, thereby making it possible to maintain the lubricating performance for a long time. Further, an oil hole 2 is formed for supplying lubricating oil to the outer race 10. Therefore, even when the amount of the lubricating oil component of the retaining material 2 is decreased, the additional lubricant can be supplied from the oil hole 12.

Further, according to the embodiment, the extension of the retaining material 2 to the end faces 1c of each rolling element 1 makes it possible to adequately maintain the lubricating performance between the end faces 1c and the ring-shaped portions 10a of the outer race 10.

The retaining material 2 is extended to the end faces 1c of each rolling element 1 in this manner. Further, as described earlier, the retaining material 2 makes the area of the exposed curved-face 1a of each rolling element 1 larger than that of the exposed curved-face 1b of the rolling element 1 on the other face of the coupled assembly 3. Because of this, the retaining material 2 can bridge the space h created between the shaft 11 and the ring-shaped portions 10a. The ring-shaped portions 10a are intrinsically not permitted to come into contact with the shaft 11. The space h is provided for preventing this contact. However, contamination sometimes enters from the space h. In the embodiment, the retaining material 2 bridges the space h to make it possible to prevent contamination from entering from the space h. Further, the additional lubricating oil supplied from the oil hole 12 does not leak from the space h. Accordingly, the capability of retaining the lubricating oil is improved.

1. A coupled structure of rolling elements (1) including a coupled assembly (3) of rolling elements (1) that are coupled by regularly arranging the rolling elements (1) such as needle rollers in a direction at right angles to the a longitudinal direction of the rolling element (1) and interposing a retaining material (2) formed of a solid lubricant between the rolling elements (1),
wherein a curved-face (1a) of each of the rolling elements (1) exposed on one of faces of the coupled assembly (3) is wider than a curved-face (1b) of the rolling element (1) exposed on the an other face of the coupled assembly (3).

2. A coupled structure of rolling elements (1) according to claim 1, wherein the coupled assembly (3) is bent in a ring shape with the a wider exposed curved-faces (1a) of the rolling elements (1) facing outward.

3. A coupled structure of rolling elements (1) according to claim 2, wherein the rolling elements (1) adjacent to each other are arranged close to each other and a groove is formed between the wider exposed curved-faces (1a) of the an adjacent rolling elements (1).

4. A roller bearing which includes a coupled assembly (3) constituted of rolling elements (1) such as needle rollers regularly arranged in a direction at right angles to a longitudinal direction of the rolling element (1) and a retaining material (2) formed of a solid lubricant and interposed between the rolling elements (1), and an outer race (10) on which the coupled assembly (3) bent in a ring shape is mounted,
wherein a curved-face (1a) of each of the rolling elements (1) exposed on one face of the coupled assembly (3) is wider than a curved-face (1b) of the rolling element (1) exposed on an other face of the coupled assembly (3), and the coupled assembly (3) is bent in a ring shape with wider exposed curved-faces (1a) of the rolling elements (1) facing outward, and the rolling elements (1) bent in the ring shape is mounted on the outer race (10).

5. A roller bearing according to claim 4, wherein oil-supply holes are (12) formed on the outer race (10).
